(19) United States
(12) Patent Application Publication
(10) Pub. No.: US 2019/0339757 A1
(43) Pub. Date: Nov. 7, 2019

(54) PDN RESONANCE AWARE WAKEUP CONTROL

(71) Applicant: QUALCOMM Incorporated, San Diego, CA (US)

(72) Inventors: Abinash ROY, San Diego, CA (US); Dipti Ranjan PAL, Irvine, CA (US); Avinash GADDE, San Diego, CA (US)

(21) Appl. No.: 15/967,872

(22) Filed: May 1, 2018

(51) Int. Cl. G06F 1/26

(52) U.S. Cl. CPC G06F 1/26

(57) ABSTRACT

Methods and apparatuses to power up multiple load circuits are presented. The apparatus includes a power delivery network, multiple load circuits configured to be powered via the power delivery network, and a wakeup control circuit configured to power up the multiple load circuits at a frequency based on a resonance frequency of the power delivery network. The method includes delivering power to the multiple load circuits by a power source via a power delivery network and powering up the multiple load circuits at a frequency, by a wakeup control circuit, based on a resonance frequency of the power delivery network.

### BACKGROUND

### Field

The present disclosure relates generally to methods and apparatuses each incorporating a wakeup control circuit to control power delivery to load circuits via a power delivery networks (PDN) and more particularly, to methods and apparatuses each having a PDN resonance aware wakeup control circuit.

### Background

An electronic device often incorporates a processor to perform various functions, such as telephony, internet access, camera/video function, etc. The processor may include various circuit blocks to perform those functions. In terms of power delivery and consumption, those circuit blocks may be referred to circuit loads, as the circuit blocks draw power when in operation. The circuit loads are powered from a power supply, such as battery, PMIC, wall plug-ins, or switches. The power is delivered from the power supply to the load circuits via a power delivery network (PDN). The PDN may include various routings, switches, and/or drivers. Due to the electrical characteristics of these components of the PDN, a surge of power flowing through the PDN may oscillate at a resonance frequency.

To conserve power, the circuit loads may be put into a sleep mode when not in use. The load circuits waking up (e.g., powering up) sequentially from the sleep mode or from a power down state sinks inrush current over the PDN and therefore, may trigger the resonance frequency. A PDN resonance frequency may magnified inrush current and causing a large voltage droop at the load circuits. Such large voltage droop may cause functional failure of the load circuits. Resolution of such issues may be needed to ensure safe and normal operation of electrical circuits over the PDN.

### SUMMARY

This summary identifies features of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

Aspects of an apparatus are presented. The apparatus includes a power delivery network, multiple load circuits configured to be powered via the power delivery network, and a wakeup control circuit configured to power up the multiple load circuits at a frequency based on a resonance frequency of the power delivery network.

Aspects of a method to power up multiple load circuits are presented. The method includes delivering power to the multiple load circuits by a power source via a power delivery network and powering up the multiple load circuits at a frequency, by a wakeup control circuit, based on a resonance frequency of the power delivery network.

Aspects of another apparatus are presented. The apparatus includes a first clock domain having a first plurality of load circuits and a first wakeup control circuit. The first wakeup control circuit is configured to power up the first plurality of load circuits by adjusting a first base clock frequency. The apparatus further includes a second clock domain having a second plurality of load circuits and a second wakeup control circuit. The second wakeup control circuit is configured to power up the second plurality of load circuits by adjusting a second base clock frequency, the first base clock frequency and the second base clock frequency being different. The second wakeup control circuit is further configured to power up the second plurality of load circuits triggered by the first wakeup control circuit powering up the first plurality of load circuits.

### BRIEF DESCRIPTION OF THE DRAWINGS

Various aspects of apparatus and methods will now be presented in the detailed description by way of example, and not by way of limitation, with reference to the accompanying drawings, wherein:

FIG. 1 is a diagram of an apparatus incorporating a wakeup control circuit.

FIG. 2 is a diagram of the wakeup control circuit of the apparatus of FIG. 1.

FIG. 3 is a state diagram of signals of the clock controller of FIG. 2.

FIG. 4 is a diagram of signals of the wakeup control circuit for waking up/powering up the load circuits of FIG. 2.

FIG. 5 is a diagram of supply voltages illustrating effects of the wakeup control circuit 240 of FIG. 2.

FIG. 6 is a diagram of another apparatus incorporating wakeup control circuits to wake up load circuits across clock domains.

FIG. 7 is a method to wake up/power up multiple load circuits, in accordance with certain aspects of the disclosure.

FIG. 8 is a method to wake up/power up load circuits across clock domains, in accordance with certain aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well known structures and components are shown in block diagram form to avoid obscuring such concepts.

As used herein, the term “coupled to” in the various tenses of the verb “couple” may mean that element A is directly connected to element B or that other elements may be connected between elements A and B (i.e., that element A is indirectly connected with element B). In the case of electrical components, the term “coupled to” may also be used herein to mean that a wire, trace, or other electrically conductive material is used to electrically connect elements A and B (and any components electrically connected therebetween). In some example, the term “coupled to” indicate having an electric current flowing between the elements A and B.

Methods and apparatuses having wakeup control circuits to control power delivery to load circuits via power delivery networks (PDNs) are presented via non-limiting examples. The wakeup control circuits are PDN resonance frequency aware. Waking up load circuits from a sleep mode or a power-down state via the PDN may cause a drop of a voltage supplied to the load circuits. Such voltage droop may exceed a threshold and cause various function errors in the load circuits. To manage the voltage droop issue, the wakeup control circuit may stagger the powering up of the load circuits. However, if a pace or frequency of powering up the load circuits matches the PDN resonance frequency, the voltage swing (voltage overshoot and droop) may exacerbate, as the voltage swing resonates with the PDN resonance frequency. The wakeup control circuits that are PDN resonance frequency aware may advantageously and dynamically adjust the frequency of powering up the load circuits. In some examples, the frequency of powering up the load circuits may be controlled by software. As the PDN resonance frequency may differ from board to board, the wakeup control circuits may individually adjust the power up frequencies.

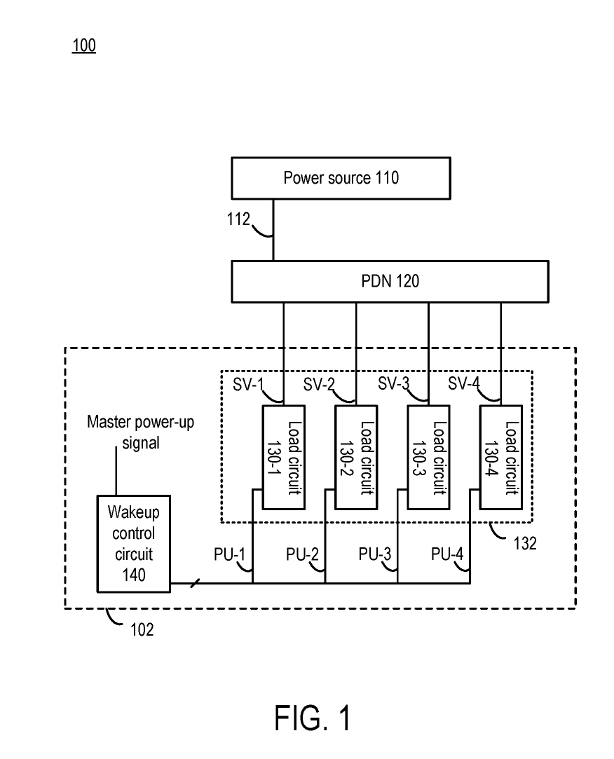

FIG. 1 is a diagram of an apparatus 100 incorporating a wakeup control circuit 140. The apparatus 100 may, for example, be one of a (datacenter or internet) server, a mobile computing system (e.g., laptop, tablet, cell phone, vehicle, etc.), an Internet of Things device, and a virtual reality or augmented reality system. The apparatus 100 includes a power source 110, a PDN 120; load circuits 132 (e.g., load circuits 130-1 to 130-4), and a wakeup control circuit 140. The PDN 120, the load circuits 130-1 to 130-4, and the wakeup control circuit 140 may be part of a clock domain 102. As presented below, the clock domain 102 wakes up or powers up the load circuits 130-1 to 130-4 based on a clock signal. These components may be on a same die or different dies. These components may be in a same package or device or different packages or devices.

The power source 110 is configured to deliver power to the load circuits 130-1 to 130-4 via the PDN 120 for waking up/powering up the load circuits 130-1 to 130-4 from a sleep or power-down state. The power source 110 may include, for example, power management integrated circuits (PMICs), low-dropout regulators (LDOs), drivers, pass gates, and/or switches.

The PDN 120 is configured to deliver power from the power source 110 to the load circuits 130-1 to 130-4 at least for powering up the load circuits 130-1 to 130-4. The PDN 120 may include conductive traces and/or passive elements (e.g., capacitors or inductors) coupled to the conductive traces. The PDN 120 may further include switches and/or drivers to control the power delivery. Electrical characteristics of the PDN 120 may include a resonance frequency. For example, to power up the load circuits 130-1 to 130-4, the power source 110 may deliver instantaneously a large amount of current/power. However due to electrical characteristics of the PDN 120, such as resistance, capacitance, and/or inductance, the large amount of current/power cannot be delivered to the load circuits 130-1 to 130-4 instantaneously. A voltage on the load circuits 130-1 to 130-4 may experience ringing due to the resonance frequency of the PDN 120.

The load circuits 130-1 to 130-4 may include various circuits for performing the functions of the apparatus 100. For example, the load circuits 130-1 to 130-4 may include memories and/or processing circuits. In some examples, each of the load circuits 130-1 to 130-4 may include a memory. The load circuits 130-1 to 130-4 are configured to be powered by the power source 110 via the PDN 120. For example, the load circuit 130-1 (130-2, 130-3, 130-4, etc.) receives supply voltage at SV-1 (SV-2, SV-3, SV4, etc.) from the power source 110, via the PDN 120. The load circuits 130-1 to 130-4 are respectively powered up by power-up signals PU-1 to PU-4. For example, the power-up signal PU-1 (PU-2, PU-3, PU-4, etc.) in a first state (e.g., logic 0) may put the load circuit 130-1 (130-2, 130-3, 130-4, etc.) in a sleep mode drawing no power from the power source 110 via the PDN 120. The power-up signal PU-1 (PU-2, PU-3, PU-4, etc.) in a second state (e.g., logic 1) may wake up the load circuit 130-1 (130-2, 130-3, 130-4, etc.) to draw power from the power source 110 via the PDN 120.

The wakeup control circuit 140 is configured to receive a master power-up signal and, in response, assert the power-up signals PU-1 to PU-4 to respectively wake up/power up the load circuits 130-1 to 130-4 (e.g., to enable the load circuits 130-1 to 130-4 to draw and receive power from the power source 110 via the PDN 120). In some examples, the wakeup control circuit 140 is configured to stagger the assertion of the power-up signals PU-1 to PU-4 to stagger the waking up/powering up of the load circuits 130-1 to 130-4. The staggered waking up/powering up of the load circuits 130-1 to 130-4 may reduce ringing on the supply voltages SV-1 to SV-4. Moreover, the wakeup control circuit 140 may be configured to power up the load circuits 130-1 to 130-4 at a frequency based on (e.g., to mitigate, to avoid, or to be different from) the resonance frequency of the PDN 120. In such fashion, ringing or voltage droops due to the resonance frequency of the PDN 120 may be mitigated.

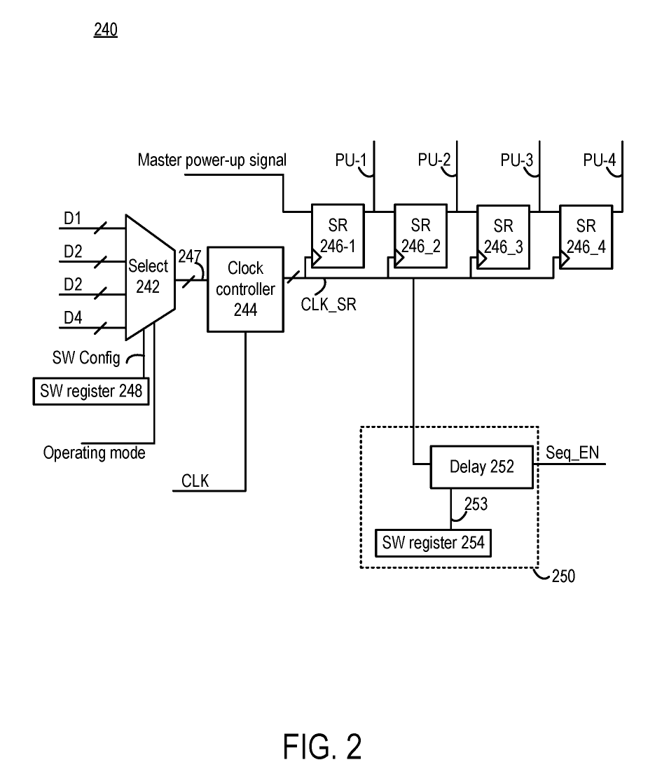

FIG. 2 is a diagram of the wakeup control circuit 240 of the apparatus 100 of FIG. 1. The wakeup control circuit 240 may be an instance of the wakeup control circuit 140 of FIG. 1 and incorporated within the apparatus 100 of FIG. 1. The wakeup control circuit 240 includes some or all of the components: select module 242, clock controller 244, SR latches 246-1 to 246-4 and SW register 248. The wakeup control circuit 240 may further include a sequential wakeup component 250. The wakeup control circuit 240 may be configured to generates the power-up signals PU-1 to PU-4 to power up the load circuits 130-1 to 130-4 (see FIG. 1). The wakeup control circuit 240 may be further configured to wake up (power up) the load circuits 130-1 to 130-4 at a frequency based on the resonance frequency and to mitigate resonance with the resonance frequency of the PDN 120 (see FIG. 1). In some examples, to mitigate resonance with the resonance frequency of the PDN 120 includes waking up/powering up the load circuits 130-1 to 130-4 at a frequency different from the resonance frequency.

The resonance frequency of the PDN 120 (FIG. 1) may be obtained by simulation or by measurement. For example, a resonance frequency of the PDN 120 (FIG. 1) may be obtained by simulating the physical characteristics of the PDN 120 (e.g., lengths and thicknesses of conductive traces of the PDN 120). In some examples, the apparatus 100 may include measuring circuits (not shown) that measures the PDN 120 for the resonance frequency.

The select module 242 is configured to select one of several delay signals D1-D4 based on software programming and/or on an operating mode of the apparatus 100 of FIG. 1. Each of the delay signals D1-D4 may be one or multiple signals. For ease of reference, each of the delay signals D1-D4 is referred to in singular. The selection may be based on software input. For example, the select module 242 receives the SW config signal (indicating the configuration set by software) stored in the SW register 248. The software input may set and/or adjust the SW register 248 to select a delay (therefore, a frequency) to power up the load circuits 130-1 to 130-4. The software input may select the delay among the delay signals D1-D4 to power up the load circuits 130-1 to 130-4 to mitigate resonance with the resonance frequency of the PDN 120. In such fashion, the wakeup control circuit 240, by way of the select module 242, wakes up/powers up the load circuits 130-1 to 130-4 based on software input.

The select module 242 may further receive an operating mode signal indicating an operating mode and select the delay signals D1-D4 based on the operating mode of the apparatus 100. For example, for a high-performance mode, more drivers in the PDN 120 may be turned on to deliver more power to meet a performance requirement of the high-performance mode. For example, the load circuits 130-1 to 130-4 may operate at the PDN resonance frequency and the resonance could be excited to cause very large voltage droops. select module 242 may, in response to the operating mode signal indicating the high-performance mode, select a different delay signals D1-D4. In such fashion, the load circuits 130-1 to 130-4 may be waken up/powered up at the frequency to mitigate resonance with at a frequency different from the resonance frequency of the PDN 120 to mitigate resonance effects based on the operating mode of the apparatus 100. The select module 242 outputs the selected delay signal (e.g., one of the delay signals D1-D4) onto 247.

The clock controller 244 is configured to adjust a delay of a base clock frequency based on the received delay signal on 247 (e.g., through clock or frequency division). In such fashion, the apparatus 100 incorporating the wakeup control circuit 240 may power up the plurality of load circuits 130-1 to 130-4 at the frequency by adjusting a base clock frequency. In some examples, the clock controller 244 receives a clock CLK as the base clock and adds a delay to a rising edge of the clock CLK based on the received delay signal on 247. The clock controller 244 outputs the delayed clock onto CLK_SR (e.g., clock or frequency division). The clock domain 102 (FIG. 2) may wake up/power up the load circuits 130-1 to 130-4 (FIG. 1) based on the clock CLK.

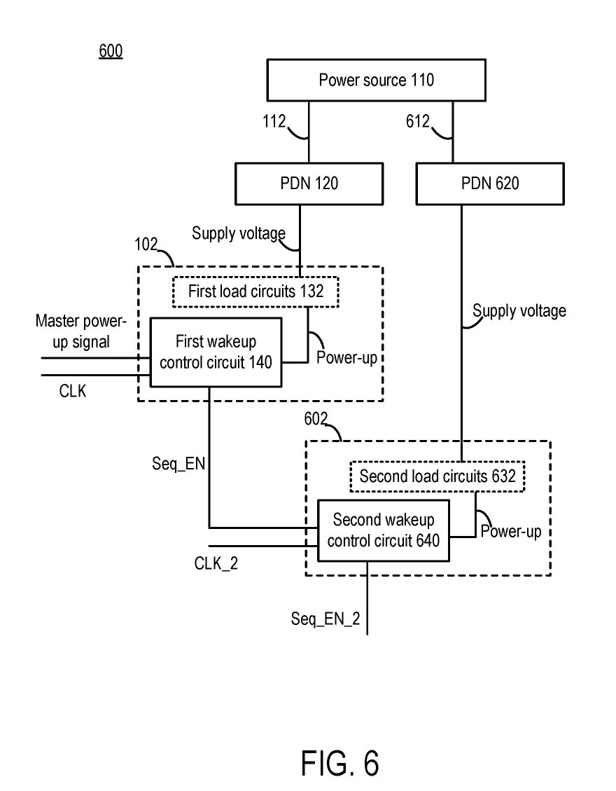

The sequential wakeup component 250 may be configured to trigger waking up/powering up of load circuits of another clock domain. The sequential wakeup component 250 is configured to receive signaling based on the waking up/powering up of the load circuits 130-1 to 130-4 of the clock domain 102 (FIG. 1). For example, the sequential wakeup component 250 receives one of the power up signals PU-1 to PU-4. Further, a SW register 254, programmed by software, store a delay for the received one of the power up signals PU-1 to PU-4. The SW register 254 controls the delay 252, which is configured to delay the received one of the power up signals PU-1 to PU-4 by a time period set by the SW register 254. A delay 252 may be, for example, counters. The sequential wakeup component 250 outputs the delayed, received one of the power up signals PU-1 to PU-4 as a seq_EN signal to power up load circuits of a different clock domain. Further details on waking up/powering up load circuits across clock domains are presented with FIG. 6.

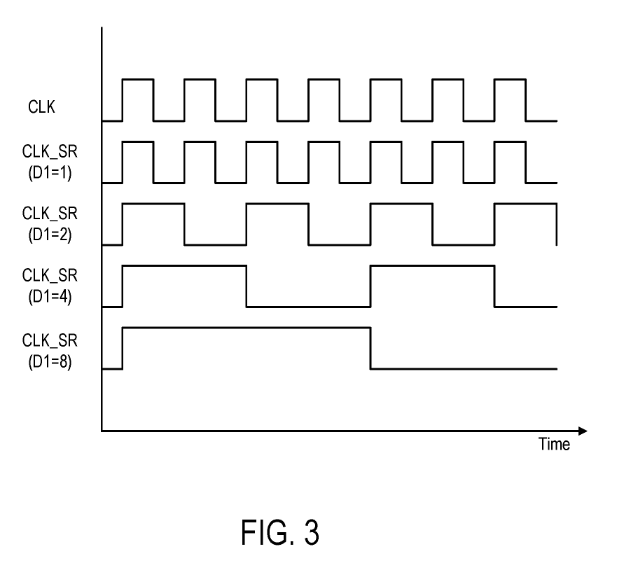

FIG. 3 is a state diagram of signals of the clock controller 244 of FIG. 2. FIG. 3 illustrates states of the clock CLK and the clocks CLK_SR based on a value of the delay signal D1 (e.g., the delay signal D1 is selected by the select module 242 based on the SW config signal and the operating mode signal). In this example, the clock controller 244 is configured to adjust the frequency of the input clock CLK by dividing the frequency of the clock CLK. The clock controller 244 may adjust the frequency of the input clock CLK in different fashion. For example, the clock controller 244 may divide the frequency of the input clock CLK using different dividers for the delay signals D2-D3.

FIG. 3 illustrates that in a case the delay signal D1 is 1 (and the delay signal D1 is selected and put onto 247 of FIG. 2), the clock controller 244 does not divide the frequency of the clock CLK. The outputted delayed clock signal CLK_SR would be at a same frequency as the clock CLK. In a case the delay signal D1 is two (and the delay signal D1 is selected and put onto 247 of FIG. 2), the clock controller 244 divides the frequency of the clock CLK by two. The outputted delayed clock signal CLK_SR would be at half the frequency of the clock CLK. In a case the delay signal D1 is four (and the delay signal D1 is selected and put onto 247 of FIG. 2), the clock controller 244 divides the frequency of the clock CLK by four. The outputted delayed clock signal CLK_SR would be a quarter the frequency of the clock CLK. In a case the delay signal D1 is eight (and the delay signal D1 is selected and put onto 247 of FIG. 2), the clock controller 244 divides the frequency of the clock CLK by eight. The outputted delayed clock signal CLK_SR would be one eighth the frequency of the clock CLK.

Referring to FIG. 2, the SR latches 246-1 to 246-4 are configured to output the power-up signals PU-1 to PU-4 to wake up/power up the load circuits 130-1 to 130-4 (see FIG. 1). In some examples, the SR latches 246-1 to 246-4 are clocked by the delayed clock CLK_SR. The SR latch 246-1 receives the power up signal indicating waking up/powering up the load circuits 130-1 to 130-4. The SR latches 246-1 to 246-4 may form a chain. For example, the output of the SR latch 246-1 is provided as an input to the SR latch 246-2, and so forth. At a first rising edge of the delayed clock CLK_SR, the SR latch 246-1 outputs the asserted signal onto the power-up signal PU-1. The power-up signal PU-1 is provided to the load circuit 130-1 to wake up/power up the load circuit 130-1. At a second rising edge of the delayed clock CLK_SR (delayed by the clock controller 244 in accordance with the received delay signal on 247), the SR latch 246-2 latches the inputted power-up signal PU-1 and outputs the asserted signal onto the power-up signal PU-2. The power-up signal PU-2 is provided to the load circuit 130-2 to wake up/power up the load circuit 130-2.

At a third rising edge of the delayed clock CLK_SR (delayed by the clock controller 244 in accordance with the received delay signal on 247), the SR latch 246-3 latches the inputted power-up signal PU-2 and outputs the asserted signal onto the power-up signal PU-3. The power-up signal PU-3 is provided to the load circuit 130-3 to wake up/power up the load circuit 130-3. At a fourth rising edge of the delayed clock CLK_SR (delayed by the clock controller 244 in accordance with the received delay signal on 247), the SR latch 246-4 latches the inputted power-up signal PU-3 and outputs the asserted signal onto the power-up signal PU-4. The power-up signal PU-4 is provided to the load circuit 130-4 to wake up/power up the load circuit 130-4.

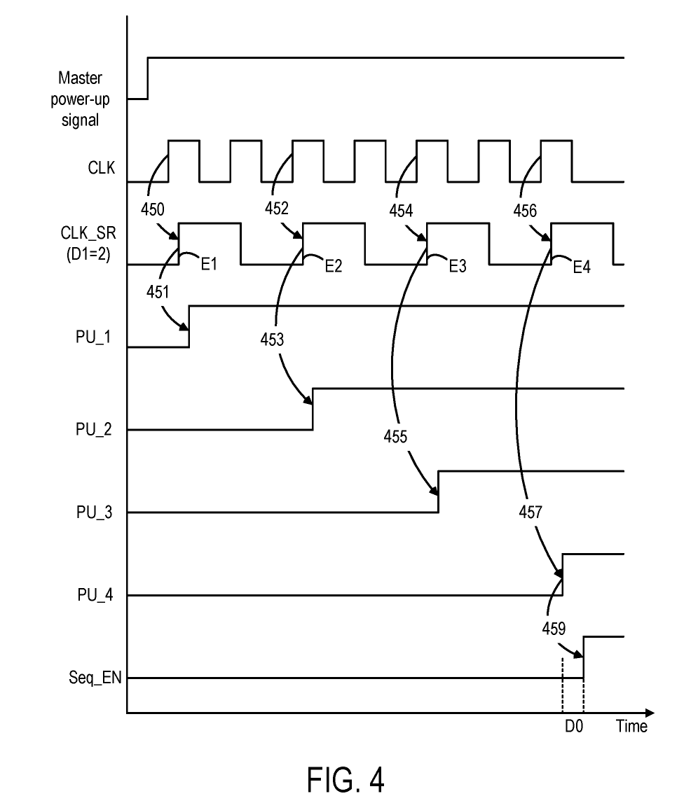

FIG. 4 is a diagram of signals of the wakeup control circuit 240 for waking up/powering up the load circuits of FIG. 2. The master power-up signal is asserted to initiate the waking up/powering up of the load circuits 130-1 to 130-4 (FIG. 1). The clock controller 244 (FIG. 2) outputs a first rising edge E1 of the delayed clock CLK_SR in response to clocking of the clock CLK (450). At the first rising edge E1 of the delayed clock CLK_SR, the SR latch 246-1 (FIG. 2) outputs and asserts the power-up signal PU-1 (451). The power-up signal PU-1 is provided to the load circuit 130-1 (FIG. 1) to wake up/power up the load circuit 130-1.

The clock controller 244 (FIG. 2) outputs a second rising edge E2 of the delayed clock CLK_SR in response to clocking of the clock CLK (452). At the second rising edge E2 of the delayed clock CLK_SR, the SR latch 246-2 (FIG. 2) outputs and asserts the power-up signal PU-2 (453). The power-up signal PU-2 is provided to the load circuit 130-2 (FIG. 1) to wake up/power up the load circuit 130-2. The clock controller 244 (FIG. 2) outputs a third rising edge E3 of the delayed clock CLK_SR in response to clocking of the clock CLK (454). At the second rising edge E3 of the delayed clock CLK_SR, the SR latch 246-3 (FIG. 2) outputs and asserts the power-up signal PU-3 (455). The power-up signal PU-3 is provided to the load circuit 130-3 (FIG. 1) to wake up/power up the load circuit 130-3. The clock controller 244 (FIG. 2) outputs a third rising edge E4 of the delayed clock CLK_SR in response to clocking of the clock CLK (456). At the second rising edge E4 of the delayed clock CLK_SR, the SR latch 246-4 (FIG. 2) outputs and asserts the power-up signal PU-4 (457). The power-up signal PU-4 is provided to the load circuit 130-4 (FIG. 1) to wake up/power up the load circuit 130-4.

The seq_EN signal is asserted after a delay programmed by software. Referring to FIG. 2, the sequential wakeup component 250 receives the power up signal PU-4 in the example. After a delay D0 (programmed by software via the SW register 254 of FIG. 2), the sequential wakeup component 250 asserts the seq_EN signal to trigger waking up/powering up of load circuits of another clock domain.

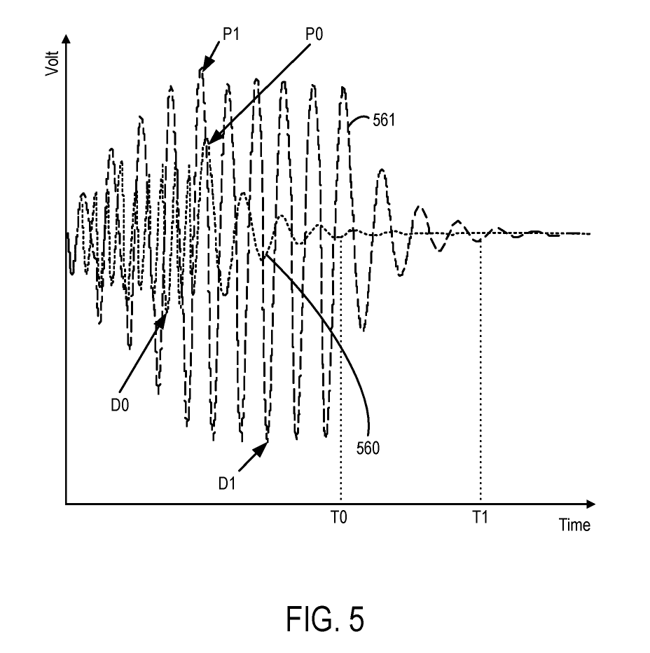

FIG. 5 is a diagram of supply voltages illustrating effects of the wakeup control circuit 240 of FIG. 2. The supply voltages may be, for example, the supply voltage at SV-1 (FIG. 1). The waveform 560 is the supply voltage SV-1 according to certain features of the present disclosure. For example, the waveform 560 may be the supply voltage SV-1 resulted from operating the wakeup control circuit 240 of FIG. 2. The waveform 561 is the supply voltage SV-1 without utilizing features of the present disclosure and experiences ringing due to a resonance frequency of the PDN 120. As shown the ringing of the waveform 561 demonstrates greater voltage overshoots and droops. FIG. 5 illustrates that waveform 560 exhibits less ringing (smaller voltage overshoots and droops) than the waveform 561. The waveform 560 includes a peak Po (voltage overshoot) and a bottom D0 (voltage droop), and the waveform 561 includes a peak P1 and a bottom D. The peak P0 is lower than the peak P1, and the bottom D0 is higher than the bottom D1. A voltage swing of the waveform 560 is thus smaller than a voltage swing of the waveform 561. Moreover, the waveform 560 exhibits a shorter settling time TO than a settling time T1 of the waveform 56. As a result, an apparatus operating according to certain features of the present disclosure would receive the supply voltage SV-1 a more stable voltage supply, compared to ones without utilizing the features of the present disclosure.

FIG. 6 is a diagram of another apparatus incorporating wakeup control circuits to wake up/power up load circuits across clock domains. The terms “first” and “second” are used for referencing and for distinguishing elements and are not substantive modifiers. The apparatus 600 may, for example, be one of a (datacenter or internet) server, a mobile computing system (e.g., laptop, tablet, cell phone, vehicle, etc.), an Internet of Things device, and a virtual reality or augmented reality system. A first clock domain 102 includes a first plurality of load circuits 132 and a first wakeup control circuit 140 (see FIG. 1). The first wakeup control circuit 140 is configured to receive a clock CLK and to power up the first plurality of load circuits 132 by adjusting a first base clock frequency provided by the clock CLK.

A second clock domain 602 includes a second plurality of load circuits 632 and a second wakeup control circuit 640. The second plurality of load circuits 632 may be an instance of the first plurality of load circuits 132, and the second wakeup control circuit 640 may be an instance of the first wakeup control circuit 140 (see FIG. 1). The second wakeup control circuit 640 is configured is configured to receive a second clock CLK_2 and to power up the second plurality of load circuits 632 by adjusting a second base clock frequency provided by the second clock CLK. In some examples, the first base clock frequency and the second base clock frequency are different frequencies.

The first plurality of load circuits 132 of the first clock domain 102 is powered by the power source 110 via the PDN 120 (FIG. 1). The second plurality of load circuits 632 of the second clock domain 602 is powered by the power source 110 via a PDN 620. The PDN 620 may be an instance of the PDN 120 of FIG. 1. In some examples, the first clock domain 102 and the second clock domain 602 may be powered by different power sources. In some examples, the first clock domain 102 and the second clock domain 602 may share a PDN. The components of the apparatus 600 may be part of a same die or different dies and packages. In some examples, the first wakeup control circuit 140 may be configured to power up the first plurality of load circuits 132 at a frequency based on (e.g., to avoid or to mitigate) a resonance frequency of the power delivery network 120.

The second wakeup control circuit 640 is further configured to power up the second plurality of load circuits 632 triggered by the first wakeup control circuit 140 powering up the first plurality of load circuits. For example, the second wakeup control circuit 640 receives a seq_EN signal from the first wakeup control circuit 140. The first wakeup control circuit 140 is configured to assert the seq_EN signal as part of the process to wake up/power up the first plurality of load circuits 132. The second wakeup control circuit 640 waking up/powering up the second plurality of load circuits 132 is triggered (e.g., enabled) by the assertion of the seq_EN signal (see FIG. 2). In some examples, the second wakeup control circuit 640 may receive the seq_EN signal as a master power-up signal. In some examples, the second wakeup control circuit 640 may be configured to power up the first plurality of load circuits 632 at a frequency based on (e.g., to avoid or to mitigate) a resonance frequency of the power delivery network 620.

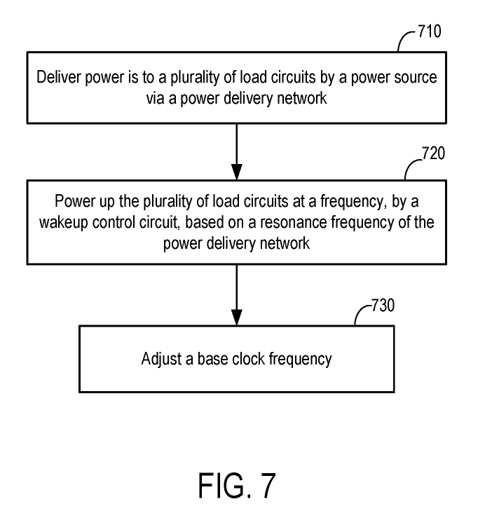

FIG. 7 is a method to wake up/power up multiple load circuits, in accordance with certain aspects of the disclosure. The operations of FIG. 7 may be implemented by, for example, the apparatus 100 presented with FIGS. 1 and 2. The arrows indicate certain relationships among the operations, but not necessarily sequential relationships. At 710, power is delivered to a plurality of load circuits by a power source via a power delivery network. Referring to FIG. 1, the power source 110 delivers power to the plurality of load circuits 130-1 to 130-4 via the PDN 120. For example, the power source 110 may be a PMIC outputting a voltage onto 112. The voltage at 112 is provided via the PDN 120 as the supply voltage at SV-1 to the load circuit 130-1 (and/or the supply voltage at SV-2 to the load circuit 130-2, etc.).

At 720, the plurality of load circuits is powered up at a frequency based on a resonance frequency of the power delivery network. For example, referring to FIG. 1, the wakeup control circuit 140 powers up the plurality of load circuits 130-1 to 130-4 at a frequency based on the resonance frequency of the PDN 120. The resonance frequency of the PDN 120 (FIG. 1) is obtained by simulation or by measurement. For example, a resonance frequency of the PDN 120 (FIG. 1) may be obtained by simulating the physical characteristics of the PDN 120 (e.g., lengths and thicknesses of conductive traces of the PDN 120). In some examples, the apparatus 100 may include measuring circuits (not shown) that measures the PDN 120 for the resonance frequency.

Referring to FIG. 2, the select module 242 selects one of several delay signals D1-D4 based on software programming. The selection is based on software input. For example, the select module 242 receives the SW config signal (indicating the configuration set by software) stored in the SW register 248. The software input sets and/or adjusts the SW register 248 to select a delay (therefore, a frequency) to power up the load circuits 130-1 to 130-4. The software input selects the delay among the delay signals D1-D4 to power up the load circuits 130-1 to 130-4 to mitigate resonance with the resonance frequency of the PDN 120. In such fashion, the wakeup control circuit 240, by way of the select module 242, wakes up/powers up the load circuits 130-1 to 130-4 based on software input.

At 730, a base clock frequency is adjusted. Referring to FIG. 2, the clock controller 244 adjusts a delay of a base clock frequency (of the clock CLK) based on the received delay signal on 247. In such fashion, the apparatus 100 incorporating the wakeup control circuit 240 powers up the plurality of load circuits 130-1 to 130-4 at the frequency by adjusting a base clock frequency of the clock CLK. In some examples, the clock controller 244 receives a clock CLK as the base clock and adds a delay to a rising edge of the clock CLK based on the received delay signal on 247. Referring to FIG. 3, the clock controller 244 divides the frequency of the base clock frequency of the clock CLK and generates output the delayed clock CLK_SR.

Referring to FIG. 2, the clock controller 244 outputs the delayed clock CLK_SR to clock the SR latches 246-1 to 246-4. The SR latches 246-1 to 246-4 outputs the power-up signals PU-1 to PU-4 to wake up/power up the load circuits 130-1 to 130-4 (FIG. 1) based on the frequency of the delayed clock CLK_SR.

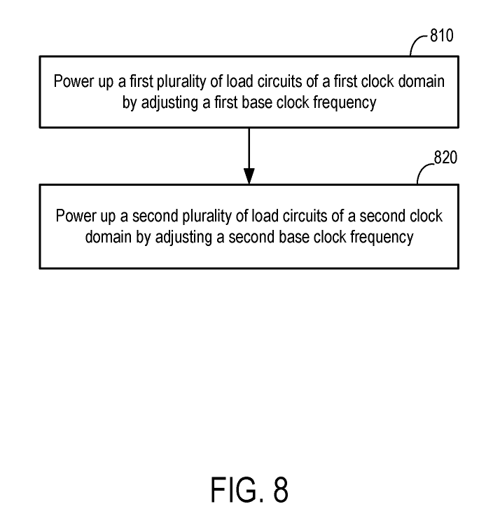

FIG. 8 is a method to wake up/power up load circuits across clock domains, in accordance with certain aspects of the disclosure. The operations of FIG. 8 may be implemented by, for example, the apparatus 600 presented with FIG. 6 (which may incorporate apparatus 100 presented with FIGS. 1 and 2). The arrows indicate certain relationships among the operations, but not necessarily sequential relationships.

At 810, a first plurality of load circuits of a first clock domain is powered up by adjusting a first base clock frequency. Referring to FIG. 6, a first clock domain 102 includes a first plurality of load circuits 132 and a first wakeup control circuit 140 (see FIG. 1). The first wakeup control circuit 140 receives a clock CLK and powers up the first plurality of load circuits 132 by adjusting a first base clock frequency provided by the clock CLK. The first wakeup control circuit 140 powers up the first plurality of load circuits 132 at a frequency based on (e.g., to avoid or to mitigate) a resonance frequency of the power delivery network 120.

At 820, a second plurality of load circuits of a second clock domain is powered up by adjusting a second base clock frequency. Referring to FIG. 6, a second clock domain 602 includes a second plurality of load circuits 632 and a second wakeup control circuit 640. The second wakeup control circuit 640 receives a clock CLK_2 and powers up the second plurality of load circuits 632 by adjusting a second base clock frequency provided by the clock CLK_2. The First base clock frequency and the second base clock frequency are different. The second wakeup control circuit 640 powers up the second plurality of load circuits 632 at a frequency based on (e.g., to avoid or to mitigate) a resonance frequency of the power delivery network 620.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus, comprising:
a power delivery network;
a plurality of load circuits configured to be powered via the power delivery network;
a wakeup control circuit configured to power up the plurality of load circuits at a frequency based on a resonance frequency of the power delivery network.

2. The apparatus of claim 1, wherein the plurality of load circuits is powered up at the frequency to mitigate resonance with the resonance frequency of the power delivery network.

3. The apparatus of claim 1, wherein the wakeup control circuit is further configured to power up the plurality of load circuits at the frequency based on software input.

4. The apparatus of claim 3, wherein the wakeup control circuit is further configured to power up the plurality of load circuits at the frequency based on an operating mode.

5. The apparatus of claim 4, wherein the wakeup control circuit is further configured to power up the plurality of load circuits at the frequency by adjusting a base clock frequency.

6. The apparatus of claim 1, wherein each of the plurality of load circuits comprises a memory.

7. The apparatus of claim 1, further comprising one of a server, a mobile computing device, an Internet of Things device, and a virtual reality or augmented reality device incorporating the power delivery network, the plurality of load circuits, and the wakeup control circuit.

8. The apparatus of claim 7, further comprising a power source configured deliver power to the plurality of load circuits via the power delivery network for powering up the plurality of load circuits.

9. A method to power up a plurality of load circuits, comprising:
delivering power to the plurality of load circuits by a power source via a power delivery network; and
powering up the plurality of load circuits at a frequency, by a wakeup control circuit, based on a resonance frequency of the power delivery network.

10. The method of claim 9, wherein the plurality of load circuits is powered up at the frequency to mitigate resonance with the resonance frequency of the power delivery network.

11. The method of claim 9, wherein powering up the plurality of load circuits at the frequency is based on software input.

12. The method of claim 11, wherein the powering up the plurality of load circuits at the frequency is based on an operating mode.

13. The method of claim 12, the powering up the plurality of load circuits at the frequency comprises adjusting a base clock frequency.

14. An apparatus, comprising:
a first clock domain comprising a first plurality of load circuits and a first wakeup control circuit, wherein the first wakeup control circuit is configured to power up the first plurality of load circuits by adjusting a first base clock frequency;
a second clock domain comprising a second plurality of load circuits and a second wakeup control circuit,
wherein the second wakeup control circuit is configured to power up the second plurality of load circuits by adjusting a second base clock frequency, the first base clock frequency and the second base clock frequency being different, and
wherein the second wakeup control circuit is further configured to power up the second plurality of load circuits triggered by the first wakeup control circuit powering up the first plurality of load circuits.

15. The apparatus of claim 14, further comprising one of a server, a mobile computing device, an Internet of Things device, and a virtual reality or augmented reality device incorporating the first clock domain and the second clock domain.

16. The apparatus of claim 15, comprising:
a power delivery network, wherein the first plurality of load circuits is configured to be powered via the power delivery network, and the first wakeup control circuit is configured to power up the first plurality of load circuits at a frequency based on a resonance frequency of the power delivery network.

17. The apparatus of claim 15, comprising:
a power delivery network, wherein the second plurality of load circuits is configured to be powered via the power delivery network, and the second wakeup control circuit is configured to power up the second plurality of load circuits at a frequency based on a resonance frequency of the power delivery network.
